(19) United States
(12) Patent Application Publication
(10) Pub. No.: US 2024/0367970 A1
(43) Pub. Date: Nov. 7, 2024

(54) HYDROGEN PRODUCTION PROCESS WITH IMPROVED CO2 FRACTIONATION PROCESS

(71) Applicant: UOP LLC, Des Plaines, IL (US)

(72) Inventors: Bradley Russell, Fall Branch, TN (US); Ahn Ngo, Carol Stream, IL (US); Glen Pomorski, Park Ridge, IL (US)

(21) Appl. No.: 18/404,994

(22) Filed: Jan. 5, 2024

Related U.S. Application Data
(60) Provisional application No. 63/499,804, filed on May 3, 2023.

(51) Int. Cl. C01B 3/50; B01D 3/14; B01D 3/34; B01D 53/047; B01D 53/26; C01B 3/56; F25J 3/02

(52) U.S. Cl. CPC C01B 3/506; B01D 3/14; B01D 3/346; B01D 53/047; B01D 53/261; C01B 3/56; F25J 3/0252; B01D 2256/16; B01D 2257/102; B01D 2257/11; B01D 2257/502; B01D 2257/504; B01D 2257/7025; B01D 2257/80; C01B 2203/042; C01B 2203/0475; C01B 2203/0495; C01B 2203/0833

(57) ABSTRACT

Hydrogen production processes with recovery of liquid or super-critical carbon dioxide using a CO₂ fractionation column are described. The processes use liquid or super-critical carbon dioxide-enriched product from the carbon dioxide recovery system to chill compressed tail gas upstream of a dehydration unit. The warm CO₂ leaving the chiller is returned to the fractionation column as stripping vapor.

### RELATED APPLICATIONS

This application claims priority to U.S. Provisional Patent Application Ser. No. 63/499,804, filed on May 3, 2023, the entirety of which is incorporated herein by reference.

### BACKGROUND

Hydrogen is expected to have significant growth potential because it is a clean-burning fuel. However, hydrogen production is traditionally a significant emitter of CO₂, and government regulations and societal pressures are increasingly taxing or penalizing CO₂ emissions or incentivizing CO₂ capture. Consequently, significant competition to lower the cost of hydrogen production while recovering the byproduct CO₂ for subsequent geological sequestration to capture the growing market is anticipated. CO₂ can be separated as a vapor to be supplied to a common pipeline, but more likely it will need to be produced in liquefied form for easy transport by truck or ship due to the current lack of CO₂ pipeline infrastructure in certain areas of the world.

The desired level of CO₂ emissions mitigated will depend on regional economic conditions, with some hydrogen producers prioritizing maximizing hydrogen production with CO₂ capture, others prioritizing minimal CO₂ emissions with hydrogen production, and some falling somewhere in-between. Another important factor is the reformer technology chosen for a given hydrogen production unit. For steam reforming plants, 50% to 60% CO₂ capture may be sufficient, while greater than 90% or greater than 95% may be expected for an autothermal reformer (ATR), gasifier, or partial oxidation (POX) reformer.

Most existing hydrogen production processes utilize pressure swing adsorption (PSA) to recover high-purity product hydrogen from shifted syngas. The low-pressure tail gas stream from the PSA unit is typically combusted to generate heat or steam for the process. If no stream is sent to a combustor, a purge is required to prevent impurity build-up in the process.

U.S. Pat. No. 8,021,464 describes a process for the combined production of hydrogen and CO₂ from a mixture of hydrocarbons which are converted to syngas. The syngas is separated in a pressure swing adsorption (PSA) unit into a hydrogen-enriched stream and a PSA offgas stream. The PSA offgas is compressed and dried, followed by several successive steps of condensing and separating the CO₂-rich condensate with the temperature being reduced at each step, the temperature ranging from ambient to −56° C. However, the process results in a purge stream containing a significant amount of CO₂ which must be removed from the process. A permeate module can be used to improve the separation, but at the cost of increased power requirements.

U.S. Pat. No. 8,241,400 describes a process for recovering hydrogen and CO2 from a mixture of hydrocarbons utilizing a system that includes a reformer unit, an optional water gas shift reactor, a PSA unit, and a cryogenic purification unit or a catalytic oxidizer. The PSA unit produces three streams: a high-pressure hydrogen stream, a low pressure CO2 stream, and a CH4 rich stream which is withdrawn during a CO2 co-purge step. Purified CO2 from the CO2 purification unit in the process is used as the co-purge in the PSA unit. The adsorption step is run at a pressure of about 250 psig to about 700 psig. the pressure during the co-purge step is in the range of about 300 psig to about 800 psig, and the CO2 co-purge stream is preferably introduced at a pressure higher than the pressure during the adsorption step. The use of a second high-pressure feed stream (the CO2 co-purge stream) increases the cost and complexity of the process in U.S. Pat. No. 8,241,400. The necessity of having a segmented adsorber (or two separate vessels) with an isolation valve between the two and an intermediate side-draw further increases the cost and complexity of the process.

Therefore, there is a need for improved hydrogen production processes with improved, cost-effective hydrogen and CO₂ recovery.

### BRIEF DESCRIPTION OF THE DRAWINGS

FIG. 1 is an illustration of one embodiment of an existing process for producing hydrogen and recovering CO₂.

FIG. 2 is an illustration of one embodiment of a process producing hydrogen and recovering CO₂ in a hydrogen production process.

### DETAILED DESCRIPTION

The present processes use liquid or super-critical carbon dioxide-enriched product from the carbon dioxide recovery system to chill compressed tail gas upstream of the dehydration unit. The dehydration load may be reduced by a factor of 2 or more, with a commensurate reduction in the size and cost of the dehydration unit. In addition, the heat recovered from the compressed process gas into the CO₂ stream is used for column reboiling duty, thereby reducing or eliminating the need for a side reboiler and a pre-heater, resulting in reduced capital cost and a lower utility requirement for dehydration unit regeneration.

Current processes typically use cooling water or air cooling on the inlet gas compressor discharge upstream of the dehydration unit. In this situation, the water load on the dehydration unit is determined by the saturated condition of the compressed tail gas at 40 to 60° C.

The present configuration chills the compressed tail gas stream to a temperature of 10 to 30° C. using liquid CO₂ from the fractionation column bottoms or super-critical CO₂ downstream of a column bottoms pump, thereby reducing the water content and the dehydration unit load. The warm CO₂ leaving the chiller is flashed and returned to the fractionation column as stripping vapor. This provides a pump-around type reboiler that replaces the current pre-heater and side reboiler (the bottom reboiler is retained).

The synthesis gas can be produced in a synthesis gas production zone which converts hydrocarbons or a carbonaceous feedstock to a synthesis gas. The synthesis gas production zone may comprise a new or existing synthesis gas reactor, including, but not limited to, a steam reforming unit with an optional gas heated reformer, an autothermal reforming (ATR) unit with an optional gas heated reformer, a gasification unit, or a partial oxidation (POX) unit, or combinations thereof.

The synthesis gas reactor produces an effluent which comprises a mixture of gases comprising hydrogen, carbon dioxide, water, and at least one of methane, carbon monoxide, nitrogen, argon, methanol, and ammonia.

The synthesis gas reactor is typically followed by a water gas shift (WGS) unit to convert carbon monoxide to carbon dioxide. The effluent stream exiting the WGS unit is typically about 220° C. to 420° C.

Heat may be recovered from the WGS effluent stream (e.g., to produce steam).

The synthesis gas feed stream from the synthesis gas production zone is typically passed to a separator where water is separated from the synthesis gas.

Before being sent to the separator, the synthesis gas feed stream may optionally be passed to a chiller where it exchanges heat with the liquid carbon dioxide-enriched product stream from the fractionation column of the carbon dioxide recovery system. Optionally, the liquid carbon dioxide-enriched product stream may be pumped to a pressure that is above the critical pressure of carbon dioxide upstream of the syngas chiller. For example, the carbon-dioxide enriched product stream may leave the fractionation column bottoms as a liquid at a pressure of 3500 kPa to 4500 kPa and then be pumped to a pressure of 7500 kPa to 8500 kPa upstream of the syngas chiller. The chiller comprises a heat exchanger, such as a shell-and-tube type heat exchanger. The carbon dioxide-enriched product stream may be on the tube side of the heat exchanger, with the synthesis gas feed stream on the shell side. The whole carbon dioxide-enriched product stream may be used for chilling the synthesis gas feed stream. Alternatively, the carbon dioxide-enriched product stream can be split before the chiller, and only a portion of the product carbon dioxide-enriched stream may be used to chill the synthesis gas feed stream. The liquid or super-critical carbon-dioxide-enriched product stream is typically at a temperature in the range of 0 to 20° C.

The synthesis gas feed stream is typically at a temperature in the range of 30 to 60° C. After chilling with the liquid or super-critical carbon-dioxide-enriched product stream, the synthesis gas stream is typically at a temperature in the range of 15 to 30° C. Liquid water is removed from the chilled syngas stream in a separator. A portion of the methanol and the ammonia in the syngas stream is removed in the liquid water stream from the separator. For example, about 20% to about 60% of the methanol and the ammonia in the syngas stream may be removed in the liquid water stream.

The synthesis gas stream is then passed to a hydrogen pressure swing adsorption (PSA) unit where it is separated into a high-pressure hydrogen product stream enriched in hydrogen, a hydrogen-depleted tail gas stream comprising the remaining hydrogen, carbon dioxide, water, and at least one of the methane, carbon monoxide, nitrogen, argon, methanol, and ammonia and optionally an additional gas stream. The high-pressure hydrogen stream, which typically contains about 80% to 90% of the hydrogen in the synthesis gas, is recovered.

The optional additional stream typically contains about 5% to 10% of the hydrogen in the synthesis gas stream and comprises hydrogen, argon, and nitrogen, and it may be used for fuel in a fired heater in the synthesis gas production process, for example.

The hydrogen depleted tail gas stream is compressed in a tail gas compressor. The compressed tail gas stream is passed to a heat exchanger where it is chilled with a portion of the liquid or super-critical carbon dioxide-enriched product stream to a temperature in the range of 10 to 40° C. The resulting heated portion of the carbon dioxide-enriched product stream is flashed and passed to the fractionation column as stripping vapor.

The remaining portion of the carbon dioxide-enriched product stream is recovered.

Liquid water is removed from the chilled compressed tail gas stream in a separator. A portion of the methanol and the ammonia in the compressed tail gas stream is removed in the liquid water stream from the separator. For example, about 20% to about 60% of the methanol and the ammonia in the compressed tail gas stream may be removed in the liquid water stream.

The stream from the separator is dried in a dehydration unit. The dehydration unit can be any suitable dehydration unit including, but not limited to, a thermal swing adsorption dehydration unit with a solid adsorbent, or a glycol dehydration unit. Suitable solid adsorbents include, but are not limited to, activated alumina, silica gel, aluminosilicate gel, or a molecular sieve zeolite, or combinations thereof.

The water load to the dehydration unit is two or more times less than the water load to a dehydration unit in a process without the heat exchanger (e.g., 2 to 5 times less).

The dried compressed tail gas stream is chilled with a refrigerant forming a chilled tail gas stream. Chilling duty is generally provided by a mechanical refrigeration system using a suitable refrigerant and a vapor compression cycle. In some cases, a mixed refrigerant may be used in order to minimize compression power. For example, a three-component mixed refrigerant comprising propane, iso-pentane, and carbon dioxide can be used.

The chilled tail gas stream is passed to a CO₂ recovery system comprising a fractionation column where it is separated into a carbon dioxide-enriched product stream and an overhead stream comprising the hydrogen, and some carbon dioxide, and some of at least one of the methane, carbon monoxide, nitrogen, and argon. Any methanol or ammonia present will be included in the carbon dioxide-enriched product stream.

All or a portion of the carbon dioxide-enriched product stream can optionally be used to chill the synthesis gas feed stream before it is sent to the separator.

In some embodiments, before chilling the dried compressed tail gas stream with the refrigerant, the dried compressed tail gas stream is first chilled with a reboiler stream comprising carbon dioxide from the fractionation column in a CO₂ fractionation column reboiler. The heated reboiler stream is flashed and returned to the fractionation column as stripping vapor.

The overhead stream is chilled and separated in an accumulator into a liquid CO₂ reflux stream and a second overhead stream. The liquid CO₂ reflux stream is returned to the fractionation column.

The second overhead stream is heated and passed to an overhead PSA unit that produces a low-pressure CO₂ recycle stream enriched in carbon dioxide and an off-gas stream enriched in hydrogen and at least one of carbon monoxide, methane, nitrogen, and argon. The CO₂ recycle stream is passed to the tail gas compressor.

The off-gas stream from the overhead PSA unit may be passed to a second PSA unit (not shown) for separation into an additional purified high-pressure hydrogen product stream and a low pressure tail gas stream, which can be combusted as fuel, recycled to the synthesis gas production unit, or both. Alternatively, the off-gas stream can be sent to a gas turbine or co-generation system for generation of electric power and steam. Another possibility is sending the off-gas stream to a membrane separation unit with the permeate being enriched in hydrogen which can be used as a clean fuel product and the residue recycled to the synthesis gas production unit.

One aspect of the invention is a hydrogen production process with recovery of liquid or super-critical carbon dioxide using a CO₂ fractionation column. In one embodiment, the process comprises providing a synthesis gas feed stream comprising hydrogen, carbon dioxide, and at least one of carbon monoxide, methane, water, nitrogen, argon, methanol, and ammonia. The synthesis gas feed stream is separated in a hydrogen pressure swing adsorption (PSA) unit to form a high-pressure hydrogen product stream enriched in hydrogen, a hydrogen-depleted tail gas stream, and optionally an additional gas stream. The hydrogen-depleted tail gas stream is compressed in a tail gas compressor forming a compressed tail gas stream. The compressed tail gas stream is chilled with a first portion of a liquid or super-critical carbon dioxide-enriched product stream in a heat exchanger forming a chilled compressed tail gas stream and a heated first portion of the carbon dioxide-enriched product stream. The heated first portion of the carbon dioxide-enriched product stream is returned to the fractionation column as stripping vapor. Liquid water is removed from the chilled compressed tail gas stream in a separator, and the chilled compressed tail gas stream is dried in a dehydration unit to form a dried compressed tail gas stream. The dried compressed tail gas stream is chilled with a refrigerant forming a chilled tail gas stream. The chilled tail gas stream is fractionated in a fractionation column into the carbon dioxide-enriched product stream and an overhead gas stream.

In some embodiments, the process further comprises chilling the dried compressed tail gas stream with a bottom stream comprising carbon dioxide from the fractionation column in a fractionation column reboiler to form a second chilled dried compressed tail gas stream and a heated reboiler stream before chilling the dried compressed tail gas stream with the refrigerant.

In some embodiments, the process further comprises chilling the synthesis gas feed stream with the carbon dioxide-enriched product stream to form a chilled synthesis gas stream before separating the synthesis gas feed stream in the PSA unit.

In some embodiments, the synthesis gas feed stream is chilled to a temperature in a range of 0° C. to 40° C.

In some embodiments, the process further comprises splitting the carbon dioxide-enriched product stream into the first portion and a second portion after chilling the synthesis gas feed stream with the carbon dioxide-enriched product stream.

In some embodiments, the compressed tail gas stream comprises at least one of methanol and ammonia and wherein a portion of the at least one of methanol and ammonia is removed in the liquid water stream from the separator.

In some embodiments, the dehydration unit comprises a thermal swing adsorption dehydration unit with a solid adsorbent, or a glycol dehydration unit. In some embodiments, the solid adsorbent comprises activated alumina, silica gel, aluminosilicate gel, a molecular sieve zeolite, or combinations thereof.

In some embodiments, the compressed tail gas stream is chilled to a temperature in a range of 10 to 40° C.

In some embodiments, the water load to the dehydration unit is two or more times less than a water load to a dehydration unit in a process in the absence of the heat exchanger.

In some embodiments, the process further comprises recovering the high-pressure hydrogen product stream, or the second portion of the carbon dioxide-enriched product stream, or both.

In some embodiments, the additional gas stream is formed in the PSA unit and wherein the additional gas stream is combusted in a fired heater.

In some embodiments, the process further comprises chilling the overhead gas stream from the fractionation column to form a chilled overhead gas stream; separating the chilled overhead stream into a liquid CO₂ reflux stream and a second overhead gas stream; and sending the liquid CO₂ reflux stream to the fractionation column.

In some embodiments, the process further comprises heating the second overhead gas stream to form a heated second overhead gas stream; separating the heated second overhead gas stream in an overhead PSA unit into a CO₂ recycle stream and an off gas stream; and recycling the CO₂ recycle stream to the tail gas compressor.

Another aspect of the invention is a hydrogen production process with recovery of liquid or super-critical carbon dioxide using a CO2 fractionation column comprising providing a synthesis gas feed stream comprising hydrogen, carbon dioxide, and at least one of carbon monoxide, methane, water, nitrogen, argon, methanol, and ammonia. The synthesis gas feed stream is chilled with a liquid or super-critical carbon dioxide-enriched product stream to form a chilled synthesis gas feed stream. The chilled synthesis gas feed stream is separated in a hydrogen pressure swing adsorption (PSA) unit to form a high-pressure hydrogen product stream enriched in hydrogen, a hydrogen-depleted tail gas stream, and optionally an additional gas stream. The hydrogen-depleted tail gas stream is compressed in a tail gas compressor forming a compressed tail gas stream. The compressed tail gas stream is chilled with a first portion of the carbon dioxide-enriched product stream in a heat exchanger forming a chilled compressed tail gas stream and a heated first portion of the carbon dioxide-enriched product stream. The heated first portion of the carbon dioxide-enriched product stream is returned to the fractionation column as stripping vapor. Liquid water is removed from the chilled compressed tail gas stream in a separator and the chilled compressed tail gas stream is dried in a dehydration unit to form a dried compressed tail gas stream. The dried compressed tail gas stream is chilled with a refrigerant forming a chilled dried tail gas stream. The chilled dried tail gas stream is fractionated in a fractionation column into the carbon dioxide-enriched product stream and an overhead gas stream. The high-pressure hydrogen product stream, or the second portion of the carbon dioxide-enriched product stream, or both is recovered.

In some embodiments, the process further comprises chilling the dried compressed tail gas stream in a CO₂ fractionation column reboiler with carbon dioxide from the fractionation column to form a chilled dried compressed tail gas stream and a heated reboiler stream before chilling the dried compressed tail gas stream with the refrigerant.

In some embodiments, the process further comprises chilling the synthesis gas feed stream with the carbon dioxide-enriched product stream to form a chilled synthesis gas stream before separating the synthesis gas feed stream in the PSA unit.

In some embodiments, the process further comprises splitting the carbon dioxide-enriched product stream into the first portion and a second portion after chilling the synthesis gas feed stream with the carbon dioxide-enriched product stream.

In some embodiments, the process further comprises splitting the carbon dioxide-enriched product stream into the first portion and a second portion; and chilling the synthesis gas feed stream with the second portion of the carbon dioxide-enriched product stream before separating the synthesis gas feed stream in the PSA unit.

In some embodiments, the process further comprises chilling the overhead gas stream from the fractionation column to form a chilled overhead gas stream; separating the chilled overhead stream into a liquid CO₂ reflux stream and a second overhead gas stream; sending the liquid CO₂ reflux stream to the fractionation column; heating the second overhead gas stream to form a heated second overhead gas stream; separating the heated second overhead gas stream in an overhead PSA unit into a CO₂ recycle stream and an off gas stream; and recycling the CO₂ recycle stream to the tail gas compressor.

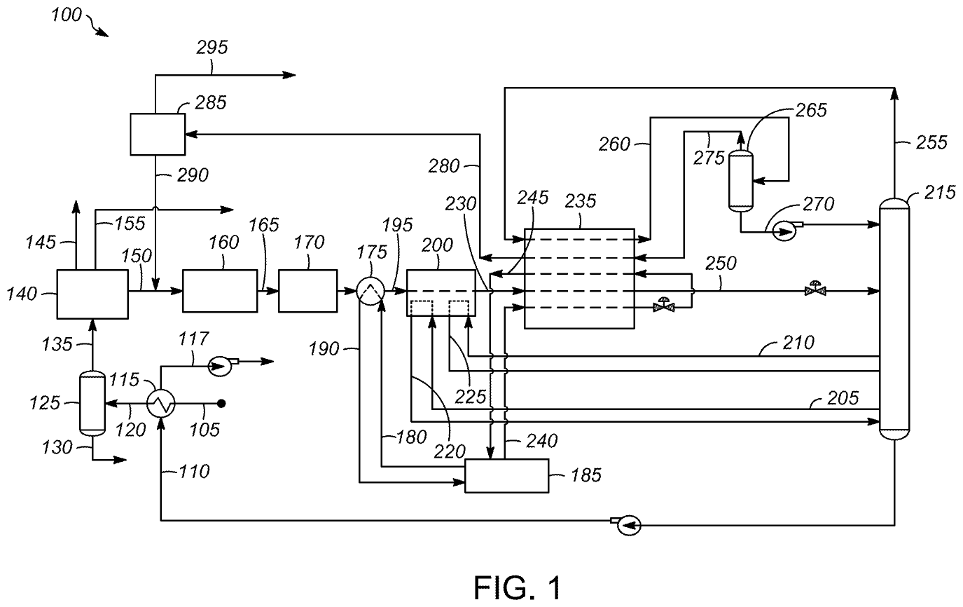

FIG. 1 illustrates a typical hydrogen production process 100 with recovery of liquid carbon dioxide using a fractionation column. The synthesis gas feed stream 105 is chilled with a carbon dioxide-enriched product stream 110 in a heat exchanger 115. The carbon dioxide-enriched product stream 117 is recovered.

The chilled feed stream 120 is passed to a separator 125 where it is separated into a liquid water stream 130 and a synthesis gas stream 135. The synthesis gas stream 135 is passed to a hydrogen PSA unit 140 where it is separated into a high-pressure hydrogen product stream 145, a tail gas stream 150, and an additional stream 155. The high-pressure hydrogen product stream 145 is recovered. The additional stream 155 can be passed to a fired heater (not shown).

The tail gas stream 150 is passed to tail gas compressor 160. The compressed tail gas stream 165 is passed to a separator (not shown) to remove liquid water and passed to dehydration unit 170. The dried compressed tail gas stream from the dehydration unit 170 is passed to a pre-heater 175 where it is heated using a compressed refrigerant stream 180 from a refrigeration unit 185. The cooled refrigeration stream 190 is returned to the refrigeration unit 185.

The heated stream 195 from the pre-heater 175 is passed to column reboiler 200. Bottom reboiler stream 205 and side reboiler stream 210 from the fractionation column 215 are passed to the column reboiler 200 to chill the heated stream 195. The heated bottom reboiler stream 220 and heated side reboiler stream 225 are returned to the fractionation column 215.

Chilled stream 230 is passed to main heat exchanger 235. Refrigerant stream 240 from the refrigeration unit 185 is passed to the main heat exchanger 235 to further chill chilled stream 230. The heated refrigerant stream 245 is returned to the refrigeration unit 185.

The chilled stream 250 is passed to fractionation column 215 where it is separated into the carbon dioxide-enriched product stream 110 and overhead gas stream 255. The overhead gas stream 255 is passed to the main heat exchanger 235 where it is chilled. The chilled overhead stream 260 is passed to accumulator 265 where it is separated into a liquid CO₂ reflux stream 270 and a second overhead gas stream 275. The liquid CO₂ reflux stream 270 is returned to the fractionation column 215.

The second overhead gas stream 275 is passed to the main heat exchanger 235 where it is heated. The heated second overhead stream 280 is passed to an overhead PSA unit 285 where it is separated into a CO₂ recycle stream 290 and an off gas stream 295. The CO₂ recycle stream 290 is passed to the tail gas compressor 160. The off gas stream 295 may be passed to a second PSA unit, sent to a gas turbine or co-generation system for generation of electric power and steam, or sent to a membrane separation unit, as discussed above.

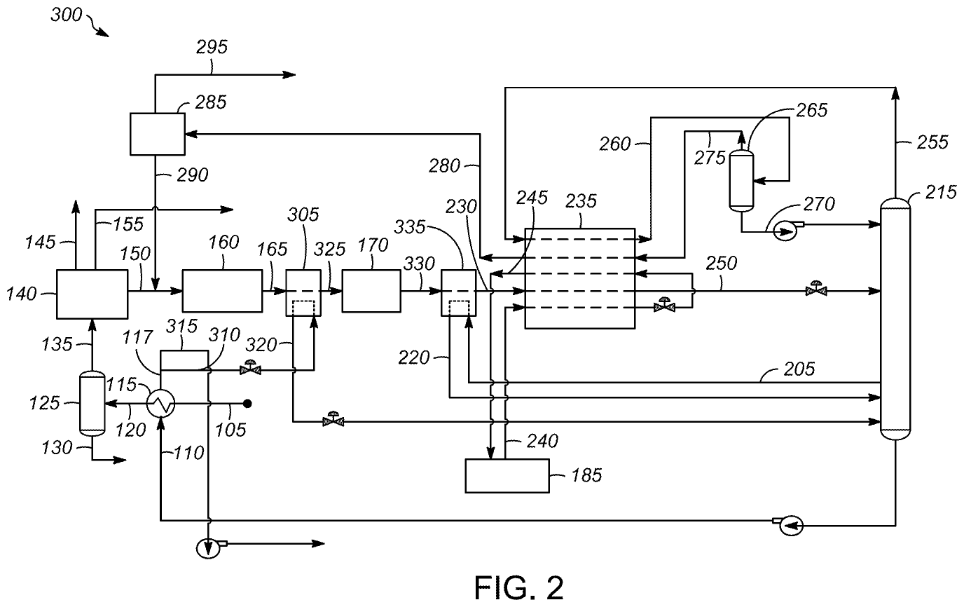

FIG. 2 illustrates one embodiment of a hydrogen production process 300 with recovery of liquid carbon dioxide using a fractionation column according to the present invention. The synthesis gas feed stream 105 is chilled with a carbon dioxide-enriched product stream 110 in a heat exchanger 115.

The chilled feed stream 120 is passed to a separator where it is separated into a liquid water stream 130 and a synthesis gas stream 135. The synthesis gas stream 135 is passed to a hydrogen PSA unit 140 where it is separated into a high-pressure hydrogen product stream 145, a tail gas stream 150, and an additional stream 155. The high-pressure hydrogen product stream 145 is recovered. The additional stream 155 can be passed to a fired heater (not shown).

The tail gas stream 150 is passed to tail gas compressor 160. The compressed tail gas stream 165 is passed to a dehydration heat exchanger 305.

The carbon dioxide-enriched product stream 117 is split into a first portion 310 and a second portion 315. The second portion 315 of the carbon dioxide-enriched product stream 117 is recovered.

The first portion 310 of the carbon dioxide-enriched product stream 117 is passed to the dehydration heat exchanger 305 where it chills the compressed tail gas stream 165. The heated first portion 320 of the carbon dioxide-enriched product stream 117 is flashed and passed to fractionation column 215 as stripping vapor.

The chilled stream 325 is passed to a separator (not shown) to remove liquid water and then to dehydration unit 170. A portion of the methanol and ammonia in chilled stream 325 is removed in the liquid water stream.

The chilled stream 330 is passed to column reboiler 335. Bottom reboiler stream 205 from the fractionation column 215 is passed to the column reboiler 335 to chill the chilled stream 330. The heated bottom reboiler stream 220 is returned to the fractionation column 215.

Chilled stream 230 is passed to main heat exchanger 235. Refrigerant stream 240 from the refrigeration unit 185 is passed to the main heat exchanger 235 to chill chilled stream 230. The heated refrigerant stream 245 is returned to the refrigeration unit 185.

The chilled stream 250 is passed to fractionation column 215 where it is separated into the carbon dioxide-enriched product stream 110 and overhead gas stream 255.

The overhead gas stream 255 is passed to the main heat exchanger 235 where it is chilled. The chilled overhead stream 260 is passed to accumulator 265 where it is separated into a liquid CO₂ reflux stream 270 and a second overhead gas stream 275. The liquid CO₂ reflux stream 270 is returned to the fractionation column 215.

The second overhead gas stream 275 is passed to the main heat exchanger 235 where it is heated. The heated second overhead stream 280 is passed to an overhead PSA unit 285 where it is separated into a CO₂ recycle stream 290 and an off gas stream 295. The CO₂ recycle stream 290 is passed to the tail gas compressor 160. The off gas stream 295 may be passed to a second PSA unit, sent to a gas turbine or co-generation system for generation of electric power and steam, or sent to a membrane separation unit, as discussed above.

### Example

A hydrogen production process based on autothermal reforming of natural gas was evaluated by computer simulations according to the process shown in FIG. 1 and FIG. 2 for recovery of hydrogen and carbon dioxide from the synthesis gas. Properties of the resulting compressed tail gas stream from the hydrogen PSA unit are given below in Table 1, along with a summary of the benefits for the dehydration unit 170. As shown in Table 1, the water load on the dehydration unit 170 is reduced from 2960 ppmv to 990 ppmv (a three-fold reduction in water molar flow rate). As a result, the size, cost, and regeneration duty of the dehydration unit is reduced.

TABLE 1

| | FIG. 1 Process | FIG. 2 Process |
|---|---|---|
| Feed Gas to Dehydration Unit | Stream 165 in | Stream 325 in |
| | FIG. 1 | FIG. 2 |
| Pressure, bar(g) | 45 | 45 |
| Temperature, ° C. | 40 | 19 |
| Flow, Nm³/hr | 133,310 | 133,100 |
| Composition, mol % | | |
| Nitrogen | 0.44 | 0.44 |
| Carbon Dioxide | 70.65 | 70.79 |
| Hydrogen | 23.26 | 23.30 |
| Methane | 3.53 | 3.54 |
| Water | 2960 ppmv | 990 ppmv |
| Carbon Monoxide | 1.50 | 1.50 |
| Argon | 0.33 | 0.33 |
| Total | 100.00 | 100.00 |
| # of Adsorber Vessels in Dehydration | 3 | 3 |
| Unit 170 | | |
| Adsorbent Volume in Dehydration Unit | 1.00 | 0.42 |
| 170, relative | | |
| Regeneration Heating Duty of | 1.00 | 0.56 |
| Dehydration Unit 170, relative | | |
| Cost of Dehydration Unit 170, relative | 1.00 | 0.84 |

As used herein, the term “stream” can include various hydrocarbon molecules and other substances.

As used herein, the term “stream”, “feed”, “product”, “part” or “portion” can include various hydrocarbon molecules, such as straight-chain and branched alkanes, naphthenes, alkenes, alkadienes, and alkynes, and optionally other substances, such as gases, e.g., hydrogen, or impurities, such as heavy metals, and sulfur and nitrogen compounds. Each of the above may also include aromatic and non-aromatic hydrocarbons.

As used herein, the term “overhead stream” can mean a stream withdrawn at or near a top of a vessel, such as a column.

As used herein, the term “bottoms stream” can mean a stream withdrawn at or near a bottom of a vessel, such as a column.

As used herein, the term “unit” can refer to an area including one or more equipment items and/or one or more sub-zones. Equipment items can include, but are not limited to, one or more reactors or reactor vessels, separation vessels, distillation towers, heaters, exchangers, pipes, pumps, compressors, and controllers. Additionally, an equipment item, such as a reactor, dehydration unit, or vessel, can further include one or more zones or sub-zones.

As depicted, process flow lines in the drawings can be referred to interchangeably as, e.g., lines, pipes, feeds, gases, products, discharges, parts, portions, or streams.

The term “passing” means that the material passes from a conduit or vessel to an object.

The terms “hydrogen-enriched” and “stream enriched in hydrogen” mean that the hydrogen content/concentration of the product stream is higher than the inlet gas stream. For example, in some embodiments, the product stream may contain greater than 40 mol % hydrogen, or greater than 50 mol %, or greater than 60 mol %, or greater than 70 mol %, or greater than 80 mol %, or greater than 90 mol %, or greater than 95 mol %, or greater than 98 mol %, or greater than 99 mol %, or greater than 99.9 mol %.

The terms “CO₂-enriched” and “stream enriched in CO₂” mean that the CO₂ content/concentration of the product stream is higher than the inlet gas stream. For example, in some embodiments, the product stream may contain greater than 40 mol % CO₂, or greater than 50 mol %, or greater than 60 mol %, or greater than 70 mol %, or greater than 80 mol %, or greater than 90 mol %, or greater than 95 mol %, or greater than 98 mol %, or greater than 99 mol %, or greater than 99.9 mol %.

As used herein, the term “about” means within 10% of the value, or within 5%, or within 1%.

### SPECIFIC EMBODIMENTS

While the following is described in conjunction with specific embodiments, it will be understood that this description is intended to illustrate and not limit the scope of the preceding description and the appended claims.

A first embodiment of the invention is a hydrogen production process with recovery of liquid or super-critical carbon dioxide using a CO₂ fractionation column comprising providing a synthesis gas feed stream comprising hydrogen, carbon dioxide, and at least one of carbon monoxide, methane, water, nitrogen, argon, methanol, and ammonia; separating the synthesis gas feed stream in a hydrogen pressure swing adsorption (PSA) unit to form a high-pressure hydrogen product stream enriched in hydrogen, a hydrogen-depleted tail gas stream, and optionally an additional gas stream; compressing the hydrogen-depleted tail gas stream in a tail gas compressor forming a compressed tail gas stream; chilling the compressed tail gas stream with a first portion of a liquid or super-critical carbon dioxide-enriched product stream in a heat exchanger forming a chilled compressed tail gas stream and a heated first portion of the carbon dioxide-enriched product stream; returning the heated first portion of the carbon dioxide-enriched product stream to the fractionation column as stripping vapor; removing liquid water from the chilled compressed tail gas stream in a separator and drying the chilled compressed tail gas stream in a dehydration unit to form a dried compressed tail gas stream; chilling the dried compressed tail gas stream with a refrigerant forming a chilled tail gas stream; and fractionating the chilled tail gas stream in a fractionation column into the carbon dioxide-enriched product stream and an overhead gas stream. An embodiment of the invention is one, any or all of prior embodiments in this paragraph up through the first embodiment in this paragraph further comprising chilling the dried compressed tail gas stream with a bottom stream comprising carbon dioxide from the fractionation column in a fractionation column reboiler to form a second chilled dried compressed tail gas stream and a heated reboiler stream before chilling the dried compressed tail gas stream with the refrigerant. An embodiment of the invention is one, any or all of prior embodiments in this paragraph up through the first embodiment in this paragraph further comprising chilling the synthesis gas feed stream with the carbon dioxide-enriched product stream to form a chilled synthesis gas stream before separating the synthesis gas feed stream in the PSA unit. An embodiment of the invention is one, any or all of prior embodiments in this paragraph up through the first embodiment in this paragraph wherein the synthesis gas feed stream is chilled to a temperature in a range of 0° C. to 40° C. An embodiment of the invention is one, any or all of prior embodiments in this paragraph up through the first embodiment in this paragraph further comprising; splitting the carbon dioxide-enriched product stream into the first portion and a second portion after chilling the synthesis gas feed stream with the carbon dioxide-enriched product stream. An embodiment of the invention is one, any or all of prior embodiments in this paragraph up through the first embodiment in this paragraph wherein the compressed tail gas stream comprises at least one of methanol and ammonia and wherein a portion of the at least one of methanol and ammonia is removed in the liquid water stream from the separator. An embodiment of the invention is one, any or all of prior embodiments in this paragraph up through the first embodiment in this paragraph wherein the dehydration unit comprises a thermal swing adsorption dehydration unit with a solid adsorbent, or a glycol dehydration unit. An embodiment of the invention is one, any or all of prior embodiments in this paragraph up through the first embodiment in this paragraph wherein the solid adsorbent comprises activated alumina, silica gel, aluminosilicate gel, a molecular sieve zeolite, or combinations thereof. An embodiment of the invention is one, any or all of prior embodiments in this paragraph up through the first embodiment in this paragraph wherein the compressed tail gas stream is chilled to a temperature in a range of 10 to 40° C. An embodiment of the invention is one, any or all of prior embodiments in this paragraph up through the first embodiment in this paragraph wherein a water load to the dehydration unit is two or more times less than a water load to a dehydration unit in a process in the absence of the heat exchanger. An embodiment of the invention is one, any or all of prior embodiments in this paragraph up through the first embodiment in this paragraph further comprising recovering the high-pressure hydrogen product stream, or the second portion of the carbon dioxide-enriched product stream, or both. An embodiment of the invention is one, any or all of prior embodiments in this paragraph up through the first embodiment in this paragraph wherein the additional gas stream is formed in the PSA unit and wherein the additional gas stream is combusted in a fired heater. An embodiment of the invention is one, any or all of prior embodiments in this paragraph up through the first embodiment in this paragraph further comprising chilling the overhead gas stream from the fractionation column to form a chilled overhead gas stream; separating the chilled overhead stream into a liquid CO₂ reflux stream and a second overhead gas stream; sending the liquid CO₂ reflux stream to the fractionation column. An embodiment of the invention is one, any or all of prior embodiments in this paragraph up through the first embodiment in this paragraph further comprising heating the second overhead gas stream to form a heated second overhead gas stream; separating the heated second overhead gas stream in an overhead PSA unit into a CO₂ recycle stream and an off gas stream; and recycling the CO₂ recycle stream to the tail gas compressor.

A second embodiment of the invention is a hydrogen production process with recovery of liquid or super-critical carbon dioxide using a CO2 fractionation column comprising providing a synthesis gas feed stream comprising hydrogen, carbon dioxide, and at least one of carbon monoxide, methane, water, nitrogen, argon, methanol, and ammonia; chilling the synthesis gas feed stream with a liquid or super-critical carbon dioxide-enriched product stream to form a chilled synthesis gas feed stream; separating the chilled synthesis gas feed stream in a hydrogen pressure swing adsorption (PSA) unit to form a high-pressure hydrogen product stream enriched in hydrogen, a hydrogen-depleted tail gas stream, and optionally an additional gas stream; compressing the hydrogen-depleted tail gas stream in a tail gas compressor forming a compressed tail gas stream; chilling the compressed tail gas stream with a first portion of the carbon dioxide-enriched product stream in a heat exchanger forming a chilled compressed tail gas stream and a heated first portion of the carbon dioxide-enriched product stream; returning the heated first portion of the carbon dioxide-enriched product stream to the fractionation column as stripping vapor; removing liquid water from the chilled compressed tail gas stream in a separator and drying the chilled compressed tail gas stream in a dehydration unit to form a dried compressed tail gas stream; chilling the dried compressed tail gas stream with a refrigerant forming a chilled dried tail gas stream; fractionating the chilled dried tail gas stream in a fractionation column into the carbon dioxide-enriched product stream and an overhead gas stream; and recovering the high-pressure hydrogen product stream, or the second portion of the carbon dioxide-enriched product stream, or both. An embodiment of the invention is one, any or all of prior embodiments in this paragraph up through the second embodiment in this paragraph further comprising chilling the dried compressed tail gas stream in a CO₂ fractionation column reboiler with carbon dioxide from the fractionation column to form a chilled dried compressed tail gas stream and a heated reboiler stream before chilling the dried compressed tail gas stream with the refrigerant. An embodiment of the invention is one, any or all of prior embodiments in this paragraph up through the second embodiment in this paragraph further comprising chilling the synthesis gas feed stream with the carbon dioxide-enriched product stream to form a chilled synthesis gas stream before separating the synthesis gas feed stream in the PSA unit. An embodiment of the invention is one, any or all of prior embodiments in this paragraph up through the second embodiment in this paragraph further comprising; splitting the carbon dioxide-enriched product stream into the first portion and a second portion after chilling the synthesis gas feed stream with the carbon dioxide-enriched product stream. An embodiment of the invention is one, any or all of prior embodiments in this paragraph up through the second embodiment in this paragraph further comprising; splitting the carbon dioxide-enriched product stream into the first portion and a second portion; and chilling the synthesis gas feed stream with the second portion of the carbon dioxide-enriched product stream before separating the synthesis gas feed stream in the PSA unit. An embodiment of the invention is one, any or all of prior embodiments in this paragraph up through the second embodiment in this paragraph further comprising chilling the overhead gas stream from the fractionation column to form a chilled overhead gas stream; separating the chilled overhead stream into a liquid CO₂ reflux stream and a second overhead gas stream; sending the liquid CO₂ reflux stream to the fractionation column; heating the second overhead gas stream to form a heated second overhead gas stream; separating the heated second overhead gas stream in an overhead PSA unit into a CO₂ recycle stream and an off gas stream; and recycling the CO₂ recycle stream to the tail gas compressor.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A hydrogen production process with recovery of liquid or super-critical carbon dioxide using a CO₂ fractionation column comprising:
providing a synthesis gas feed stream comprising hydrogen, carbon dioxide, and at least one of carbon monoxide, methane, water, nitrogen, argon, methanol, and ammonia;
separating the synthesis gas feed stream in a hydrogen pressure swing adsorption (PSA) unit to form a high-pressure hydrogen product stream enriched in hydrogen, a hydrogen-depleted tail gas stream, and optionally an additional gas stream;
compressing the hydrogen-depleted tail gas stream in a tail gas compressor forming a compressed tail gas stream;
chilling the compressed tail gas stream with a first portion of a liquid or super-critical carbon dioxide-enriched product stream in a heat exchanger forming a chilled compressed tail gas stream and a heated first portion of the carbon dioxide-enriched product stream;
returning the heated first portion of the carbon dioxide-enriched product stream to the fractionation column as stripping vapor;
removing liquid water from the chilled compressed tail gas stream in a separator and drying the chilled compressed tail gas stream in a dehydration unit to form a dried compressed tail gas stream;
chilling the dried compressed tail gas stream with a refrigerant forming a chilled tail gas stream; and
fractionating the chilled tail gas stream in a fractionation column into the carbon dioxide-enriched product stream and an overhead gas stream.

2. The process of claim 1 further comprising:
chilling the dried compressed tail gas stream with a bottom stream comprising carbon dioxide from the fractionation column in a fractionation column reboiler to form a second chilled dried compressed tail gas stream and a heated reboiler stream before chilling the dried compressed tail gas stream with the refrigerant.

3. The process of claim 1 further comprising:
chilling the synthesis gas feed stream with the carbon dioxide-enriched product stream to form a chilled synthesis gas stream before separating the synthesis gas feed stream in the PSA unit.

4. The process of claim 3 wherein the synthesis gas feed stream is chilled to a temperature in a range of 0° C. to 40° C.

5. The process of claim 3 further comprising;
splitting the carbon dioxide-enriched product stream into the first portion and a second portion after chilling the synthesis gas feed stream with the carbon dioxide-enriched product stream.

6. The process of claim 1 wherein the compressed tail gas stream comprises at least one of methanol and ammonia and wherein a portion of the at least one of methanol and ammonia is removed in the liquid water stream from the separator.

7. The process of claim 1 wherein the dehydration unit comprises a thermal swing adsorption dehydration unit with a solid adsorbent, or a glycol dehydration unit.

8. The process of claim 7 wherein the solid adsorbent comprises activated alumina, silica gel, aluminosilicate gel, a molecular sieve zeolite, or combinations thereof.

9. The process of claim 1 wherein the compressed tail gas stream is chilled to a temperature in a range of 10 to 40° C.

10. The process of claim 1 wherein a water load to the dehydration unit is two or more times less than a water load to a dehydration unit in a process in the absence of the heat exchanger.

11. The process of claim 1 further comprising:
recovering the high-pressure hydrogen product stream, or the second portion of the carbon dioxide-enriched product stream, or both.

12. The process of claim 1 wherein the additional gas stream is formed in the PSA unit and wherein the additional gas stream is combusted in a fired heater.

13. The process of claim 1 further comprising:
chilling the overhead gas stream from the fractionation column to form a chilled overhead gas stream;
separating the chilled overhead stream into a liquid CO₂ reflux stream and a second overhead gas stream; and
sending the liquid CO₂ reflux stream to the fractionation column.

14. The process of claim 13 further comprising:
heating the second overhead gas stream to form a heated second overhead gas stream;
separating the heated second overhead gas stream in an overhead PSA unit into a CO₂ recycle stream and an off gas stream; and
recycling the CO₂ recycle stream to the tail gas compressor.

15. A hydrogen production process with recovery of liquid or super-critical carbon dioxide using a CO2 fractionation column comprising:
providing a synthesis gas feed stream comprising hydrogen, carbon dioxide, and at least one of carbon monoxide, methane, water, nitrogen, argon, methanol, and ammonia;
chilling the synthesis gas feed stream with a liquid or super-critical carbon dioxide-enriched product stream to form a chilled synthesis gas feed stream;
separating the chilled synthesis gas feed stream in a hydrogen pressure swing adsorption (PSA) unit to form a high-pressure hydrogen product stream enriched in hydrogen, a hydrogen-depleted tail gas stream, and optionally an additional gas stream;
compressing the hydrogen-depleted tail gas stream in a tail gas compressor forming a compressed tail gas stream;
chilling the compressed tail gas stream with a first portion of the carbon dioxide-enriched product stream in a heat exchanger forming a chilled compressed tail gas stream and a heated first portion of the carbon dioxide-enriched product stream;
returning the heated first portion of the carbon dioxide-enriched product stream to the fractionation column as stripping vapor;
removing liquid water from the chilled compressed tail gas stream in a separator and drying the chilled compressed tail gas stream in a dehydration unit to form a dried compressed tail gas stream;
chilling the dried compressed tail gas stream with a refrigerant forming a chilled dried tail gas stream;
fractionating the chilled dried tail gas stream in a fractionation column into the carbon dioxide-enriched product stream and an overhead gas stream; and
recovering the high-pressure hydrogen product stream, or the second portion of the carbon dioxide-enriched product stream, or both.

16. The process of claim 15 further comprising:
chilling the dried compressed tail gas stream in a CO₂ fractionation column reboiler with carbon dioxide from the fractionation column to form a chilled dried compressed tail gas stream and a heated reboiler stream before chilling the dried compressed tail gas stream with the refrigerant.

17. The process of claim 15 further comprising:
chilling the synthesis gas feed stream with the carbon dioxide-enriched product stream to form a chilled synthesis gas stream before separating the synthesis gas feed stream in the PSA unit.

18. The process of claim 17 further comprising;
splitting the carbon dioxide-enriched product stream into the first portion and a second portion after chilling the synthesis gas feed stream with the carbon dioxide-enriched product stream.

19. The process of claim 1 further comprising;
splitting the carbon dioxide-enriched product stream into the first portion and a second portion; and
chilling the synthesis gas feed stream with the second portion of the carbon dioxide-enriched product stream before separating the synthesis gas feed stream in the PSA unit.

20. The process of claim 15 further comprising:
chilling the overhead gas stream from the fractionation column to form a chilled overhead gas stream;
separating the chilled overhead stream into a liquid CO₂ reflux stream and a second overhead gas stream;
sending the liquid CO₂ reflux stream to the fractionation column;
heating the second overhead gas stream to form a heated second overhead gas stream;
separating the heated second overhead gas stream in an overhead PSA unit into a CO₂ recycle stream and an off gas stream; and
recycling the CO₂ recycle stream to the tail gas compressor.
